(19) United States
(12) Patent Application Publication
(10) Pub. No.: US 2025/0378655 A1
(43) Pub. Date: Dec. 11, 2025

(54) MOVING CONTENT EXCLUSION FOR LOCALIZATION

(71) Applicant: Apple Inc., Cupertino, CA (US)

(72) Inventors: Huiwen Guo, Newark, CA (US); Lina M Paz-Perez, Santa Clara, CA (US)

(21) Appl. No.: 19/211,758

(22) Filed: May 19, 2025

Related U.S. Application Data
(60) Provisional application No. 63/657,537, filed on Jun. 7, 2024.

(51) Int. Cl. G06T 19/00; G06T 7/246; G06T 7/73; G06V 10/72; G06V 20/20

(52) U.S. Cl. CPC G06T 19/006; G06T 7/246; G06T 7/73; G06V 10/72; G06V 20/20; G06T 2207/10016; G06T 2207/20081; G06T 2207/30244

(57) ABSTRACT

Various implementations disclosed herein include devices, systems, and methods for tracking an image-based pose of a device in a three-dimensional (3D) coordinate system based on content motion. For example, a process may include obtaining sensor data in a physical environment that includes an object. The process may further include determining a set of 3D positions of a plurality of features for a first frame that includes a 3D position of a feature corresponding to the object. The process may further include determining that the object or content associated with the object is in motion based on a change in the feature between the first frame and a second frame. The process may further include tracking an image-based pose of the device based on a subset of the plurality of features, the subset excluding one or more features associated with the object determined to be in motion.

### CROSS-REFERENCE TO RELATED APPLICATIONS

This application claims the benefit of U.S. Provisional Application Ser. No. 63/657,537 filed Jun. 7, 2024, which is incorporated herein in its entirety.

### TECHNICAL FIELD

The present disclosure generally relates to systems, methods, and electronic devices for tracking an image-based pose of a device in a three-dimensional (3D) coordinate system based on content motion detection.

### BACKGROUND

The implementation of localization of a device allows a user and/or applications on the device to locate the device's position and/or assist with navigation within a physical environment, such as a home or building. Localization of a mobile device may be determined using sensors on the device (e.g., inertial measurement unit (IMU), gyroscope, etc.), WIFI localization, or other techniques (e.g., visual inertial odometry (VIO) from image data, simultaneous localization and mapping (SLAM) systems, etc.). A global positioning system (GPS) system can also provide an approximate position of the mobile device, however, GPS is usually limited indoor due to the degradation of signals by the building structures. Additionally, existing techniques for localization of a device may be inefficient and require higher computation with increased power consumption using a mobile device, for example, based on a user capturing photos or video or other sensor data while walking around a room. Moreover, existing techniques that use pose tracking via image capture may have issues when a television or other screen in the physical environment is displaying slow moving content.

### SUMMARY

Various implementations disclosed herein include devices, systems, and methods that improves world tracking and localization of an electronic device based on vision (e.g., stereo camera images) and inertial measurement unit (IMU) systems. In various implementations, this involves identifying features in image(s) that correspond to moving content and predicting feature locations or projections to identify and remove outliers associated with the moving content. For example, when there is moving content (e.g., a television screen displaying slow moving content, hands moving in front of device, car driving by, etc.) SLAM pose tracking may mistake the moving content as part of the physical environment. Mistaking moving content as part of the physical environment may reduce tracking and localization accuracy and may result in drift of virtual content that is positioned based on that tracking and localization.

Some implementations involve identifying a set of outliers of features that correspond to a plane, where the features are associated with moving content. If the moving content corresponds to a planar region, features on that planar region may be excluded from use in localization and tracking. In other words, while presenting virtual content in a view of an extended reality (XR) environment (e.g., while wearing a head mounted device (HMD) or the like), a real time vision-based tracking and localization system (e.g., SLAM, etc.) may ignore a two-dimensional (2D) planar region within the three-dimensional (3D) XR environment (e.g., a television displaying moving content). In some implementations, the plane region's geometry may be projected back to the camera frame and use the features' 2D location for filtering. For example, filter out the 2D planar region associated with the television for any subsequent frames. Various methods may be be used for the filtering, including but not limited to filtering in 3D using the plane's geometry, project the plane back to the camera frame and use features' 2D location for filtering, and the like. In some implementations, the filtering may be applied to not only stereo based features, but also mono features (e.g., observed by only one camera).

In general, one innovative aspect of the subject matter described in this specification can be embodied in methods, at a device having a processor and one or more sensors, that include the actions of obtaining sensor data for a sequence of frames by the one or more sensors in a physical environment, where the physical environment includes an object. The actions may further include determining, based on the sensor data, a set of three-dimensional (3D) positions of a plurality of features for a first frame of the sequence of frames, the set of 3D positions including a 3D position of a feature corresponding to the object. The actions may further include determining that the object or content associated with the object is in motion based on a change in the feature between the first frame and a second frame. The actions may further include in response to determining that the object or content associated with the object is in motion, tracking an image-based pose of the device in a 3D coordinate system based, at least in part, on a subset of the plurality of features, the subset excluding one or more features associated with the object determined to be in motion.

These and other embodiments may each optionally include one or more of the following features.

In some aspects, determining that the object or content associated with the object is in motion based on a change in the feature between the first frame and the second frame includes determining a change in a motion sensor-based pose of the device between the first frame and a second frame of the sequence of frames, determining a projected two-dimensional (2D) position of the feature on the second frame based on the 3D position of the feature determined for the first frame and the change in the pose of the device, determining whether the object or content associated with the object is in motion based on the projected 2D position of the feature and an actual 2D position of the feature in the second frame.

In some aspects, determining that the object or content associated with the object is in motion based on a change in the feature between the first frame and the second frame includes determining that a distance between a first 3D position of the feature for the first frame and a second 3D position of the feature for second frame exceeds a threshold.

In some aspects, the actions further include determining that a set of 3D positions of features corresponding to the object correspond to or approximately correspond to a planar structure. In some aspects, the actions further include determining 2D locations of the features corresponding to the planar structure, and filtering a subsequent sequence of frames based on the 2D locations of the features corresponding to the planar structure.

In some aspects, the object is in motion for at least a portion of frames of the sequence of frames. In some aspects, determining that the object or content associated with the object is in motion is based on a pose of the device.

In some aspects, the actions further include determining a change in a position of a viewpoint of the device during the sequence of frames, and adjusting the image-based pose of the device in the 3D coordinate system based on the determined change in the position of the viewpoint.

In some aspects, the actions further include presenting a view of an extended reality (XR) environment on a display, wherein the view of the XR environment includes virtual content and at least a portion of the physical environment, wherein the portion of the physical environment includes the object.

In some aspects, the virtual content is adjusted based on determining to exclude the one or more features associated with the object determined to be in motion. In some aspects, the image data is determined from an image sensor signal based on a machine learning model configured to identify image portions corresponding to the object.

In some aspects, the sensor data includes image data, depth data, device pose data, or a combination thereof, for each frame of the sequence of frames. In some aspects, the device is a head-mounted device (HMD).

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1B illustrate exemplary electronic devices operating in a physical environment in accordance with some implementations.

FIG. 2A illustrates an exemplary view for a frame of an extended reality (XR) environment of the environment of FIGS. 1A or 1B and provided by a device of FIGS. 1A or 1B that includes a virtual object, in accordance with some implementations.

FIG. 2B illustrates another exemplary view for another frame of the XR environment of FIG. 2A with the virtual object in a different position, in accordance with some implementations.

FIG. 3 illustrates identifying a change in a feature between image frames, the feature corresponding to an object of FIGS. 1A and 1B, in accordance with some implementations.

FIG. 4 illustrates detecting outlier's and planar structures associated with a plurality of features, in accordance with some implementations.

FIG. 5 is a system flow diagram of an example of excluding planar data while tracking an image-based pose of a device in a 3D coordinate system based on content motion detection in accordance with some implementations.

FIG. 6 is a flowchart illustrating a method for tracking an image-based pose of a device in a 3D coordinate system based on content motion detection, in accordance with some implementations.

FIG. 7 is a block diagram of an electronic device of in accordance with some implementations.

FIG. 8 is a block diagram of an exemplary head-mounted device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

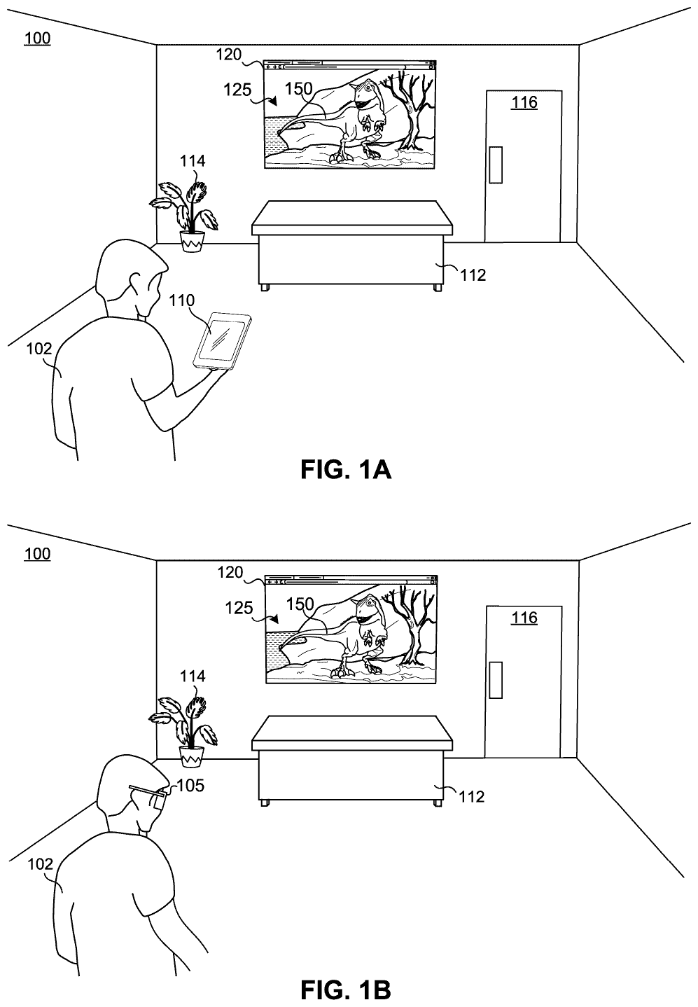

FIGS. 1A-1B illustrate exemplary electronic devices 105 and 110 operating in a physical environment 100. In the example of FIGS. 1A-1B, the physical environment 100 is a room that includes a desk 112, a plant 114, a door 116. Additionally, the physical environment 100 includes a television screen 120 displaying content 125, and in particular, displaying moving content such as, inter alia, a dinosaur character 150.

The electronic devices 105 and 110 may include one or more cameras, microphones, depth sensors, or other sensors that can be used to capture information about and evaluate the physical environment 100 and the objects within it, as well as information about the user 102 of electronic devices 105 and 110. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system (e.g., a 3D space) associated with the XR environment, which may correspond to a 3D coordinate system of the physical environment 100.

In some implementations, video (e.g., pass-through video depicting a physical environment) is received from an image sensor of a device (e.g., device 105 or device 110) and used to present the XR environment. In other implementations, optical see-through may be used to present the XR environment by overlaying virtual content on a view of the physical environment seen through a translucent or transparent display. In some implementations, a 3D representation of a virtual environment is aligned with a 3D coordinate system of the physical environment. A sizing of the 3D representation of the virtual environment may be generated based on, inter alia, a scale of the physical environment or a positioning of an open space, floor, wall, etc. such that the 3D representation is configured to align with corresponding features of the physical environment. In some implementations, a viewpoint within the 3D coordinate system may be determined based on a position of the electronic device within the physical environment. The viewpoint may be determined based on, inter alia, image data, depth sensor data, motion sensor data, etc., which may be retrieved via a virtual inertial odometry system (VIO), a simultaneous localization and mapping (SLAM) system, etc.

People may sense or interact with a physical environment or world without using an electronic device. Physical features, such as a physical object or surface, may be included within a physical environment. For instance, a physical environment may correspond to a physical city having physical buildings, roads, and vehicles. People may directly sense or interact with a physical environment through various means, such as smell, sight, taste, hearing, and touch. This can be in contrast to an extended reality (XR) environment that may refer to a partially or wholly simulated environment that people may sense or interact with using an electronic device. The XR environment may include virtual reality (VR) content, mixed reality (MR) content, augmented reality (AR) content, or the like. Using an XR system, a portion of a person's physical motions, or representations thereof, may be tracked and, in response, properties of virtual objects in the XR environment may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may have direct light representative of images to a user's eyes through a medium, such as a hologram medium, optical waveguide, an optical combiner, optical reflector, other similar technologies, or combinations thereof. Various display technologies, such as liquid crystal on silicon, LEDs, uLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

In some implementations, the devices 105 and 110 obtain physiological data (e.g., EEG amplitude/frequency, pupil modulation, eye gaze saccades, etc.) from the user 102 via one or more sensors (e.g., a user facing camera). For example, the device 110 obtains pupillary data (e.g., eye gaze characteristic data) and may determine a gaze direction of the user 102. While this example and other examples discussed herein illustrates a single device 110 in a real-world physical environment 100, the techniques disclosed herein are applicable to multiple devices and multiple sensors, as well as to other real-world environments/experiences. For example, the functions of the device 110 may be performed by multiple devices.

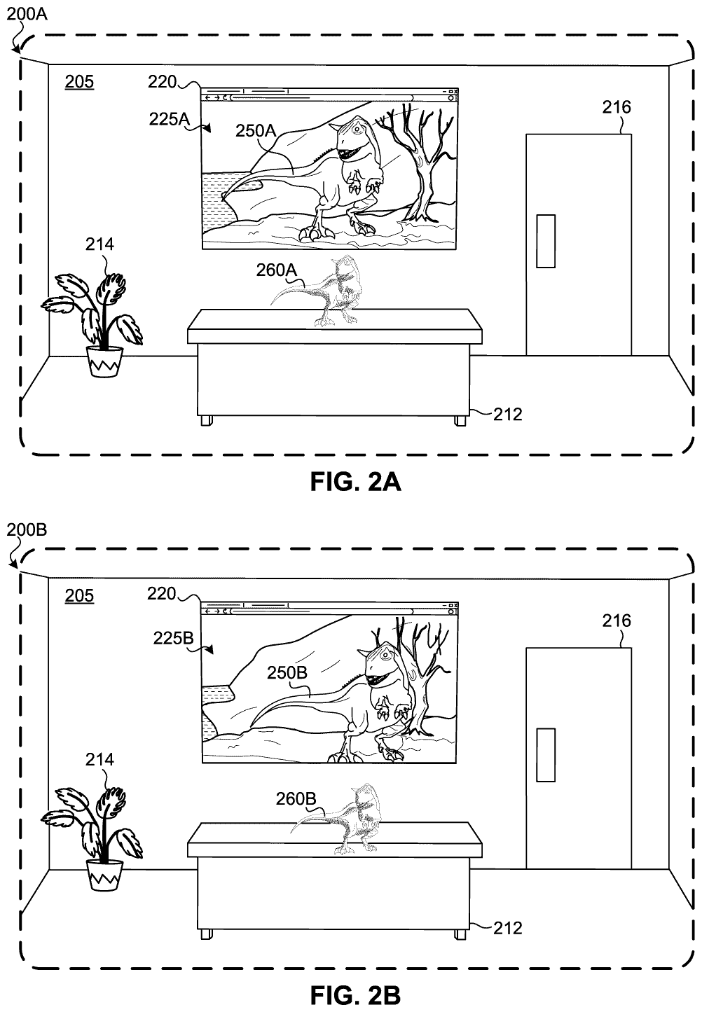

FIGS. 2A and 2B illustrate exemplary views 200A, 200B, respectively, of a 3D environment 205 provided by an electronic device (e.g., device 105 or 110 of FIG. 1). The views 200A, 200B may be a live camera view of the physical environment 100, a view of the physical environment 100 through a see-through display, or a view generated based on a 3D model corresponding to the physical environment 100. The views 200A, 200B may include depictions of aspects of the physical environment 100 such as a representation 212 of desk 112, representation 214 of plant 114, representation 216 of door 116, and representation 220 of screen 120 within a view of the 3D environment 205. In particular, view 200A of FIG. 2A illustrates providing content 225 (e.g., representation 250 of dinosaur character 150) for display on the representation 220 of the screen 120 for a first point of time (e.g., a first frame of a dinosaur video), and view 200B of FIG. 2B illustrates providing the content 225 for display within the 3D environment 205 for a second point of time (e.g., a second frame or a later frame of the dinosaur video). The content 225 in the illustrated examples provided herein (e.g., a depiction of a dinosaur walking along a rocky cliff near a body of water).

FIGS. 2A and 2B illustrate rendered content (e.g., 2D or 3D images or video, a 3D model or geometry, a combination thereof, or the like) that includes virtual content within the views 200A-200B of the 3D environment 205. For example, an application associated with the content 225 may generate a virtual object 260 (e.g., a virtual dinosaur) that is intended to walk on a surface of an object in the room such as the representation 212 of the desk 112 (as illustrated in FIG. 2A), or presented on other surfaces such as the floor, or placed in other locations in the 3D environment. For example, FIG. 2A illustrates a first frame of content 225A that includes the representation 250B of the dinosaur character 150 and the virtual object 260A for the first frame. FIG. 2B illustrates a subsequent frame of the content 225B, where the representation 250B of the dinosaur character 150 has moved (e.g., to the right), and the virtual object 260B also appears to have moved (e.g., down and to the right). However, because of the moving content from content 225A for the first frame to the content 225B for the subsequent frame, it appears the virtual object 260B has drifted away from the surface of the representation 212 of the desk 112 and appears to be floating in front of the representation 212 of the desk 112. This drift may be caused by vision-based tracking techniques (e.g., SLAM pose tracking) that may mistake the moving content of content 225 as the physical environment, and thus create some errors in localization, which in turn, can cause errors when rendering virtual content with respect to the representations of the physical environment.

In these examples of FIGS. 2A and 2B, the views of content 225 and the virtual object 260 may be rendered based on the relative positioning between the content and a viewing position (e.g., based on the position of device 105 or 110). In these examples, views of content 225 and the virtual object 260 may be rendered based on the relative positioning between the 3D model(s), representation 220 of the screen 120, a textured surface, and/or a viewing position (e.g., based on the position of device 105 or 110).

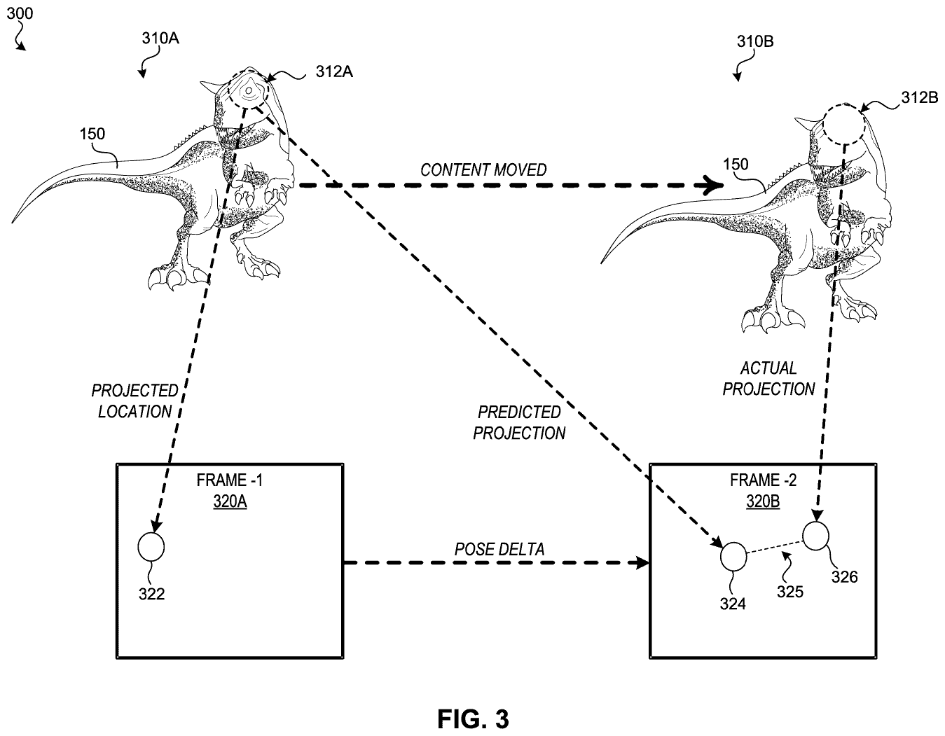

FIG. 3 illustrates identifying a change in a feature between image frames, the feature corresponding to an object of FIGS. 1A and 1B, in accordance with some implementations. FIG. 3 illustrates analyzing a particular feature in the physical environment 100 of FIG. 1, and in particular, an identified feature in the displayed content 125 on the television. For example, an identified feature of the dinosaur character 150 that may be tracked as a feature such as, inter alia, a center of an eye, as illustrated by area 312A at first point in time and 312B for a second point in time. FIG. 3 illustrates a first view 310A of a portion of content at a first point in time that coincides with view 200A of FIG. 2A, and a second view 310B of a portion of content at a second point in time that coincides with view 200B of FIG. 2B. Recall that FIGS. 1A and 1B is one singular view of the physical environment while playing a video on the television screen at one point in time (e.g., a first frame), and FIGS. 2A and 2B presents example views of a device (e.g. presentations or pass through video of the environment of FIG. 1) while the video is playing (e.g., for a first frame and a subsequent frame, thus the dinosaur has moved). In other words, FIG. 3 illustrates analyzing a feature point from the physical environment 100, such as the character 150 (e.g., the center of an eye) between two frames of image data, as the content moves (e.g., the dinosaur moves during the video playing for content 125 in FIG. 1).

In an exemplary implementation, analyzing the feature point as illustrated by area 312A in order to determine whether or not the object (or content associated with the object, such as a video playing on a television screen) is in motion, first includes identifying a 2D display position of the feature on the first image frame. Then, for another frame of image data (e.g., the video plays for one frame and the device moves for one frame), then the system determines a change in a motion sensor-based pose of the device between the first frame and a second frame of the sequence of frames (e.g., based on IMU data), in order to obtain the pose delta. The pose delta based on IMU sensor data, as illustrated in frame-2 320B, is then used to obtain the predicted projection feature point 324. In other words, predict where the 2D position of the feature point 322 from frame-1 320A should be after the device moved based on the detected motion of the device (e.g., pose delta based on IMU sensor data). Then the system obtains the actual location based on captured sensor data of the 2D position of the feature as illustrated by area 312B for the second frame (e.g., feature point 326 on frame-2 320B). A distance between the predicted projection and actual location, as illustrated by dotted line 325, is then determined between the predicted projection feature point 324 and the actual location of the feature point 326.

In some implementations, the distance between the predicted projection (e.g., projection feature point 324) and actual location (e.g., feature point 326) may be based on a number pixels between the two feature points. The determined distance may then be used to determine whether or not the object (or content associated with the object, such as a video playing on a television screen) is in motion if the distance between a first 3D position of the feature for the first frame and a second 3D position of the feature for second frame exceeds a threshold distance. For example, a delta difference between the predicted projection versus the actual feature location that is greater than the threshold distance indicates that the feature is moving. There may be some covariance in space taken into account, thus a number of pixels for the determined distance that is lower than the threshold distance may not be determined to be associated with moving content. The number of pixel threshold may be based on an amount of uncertainty there is in the localization process.

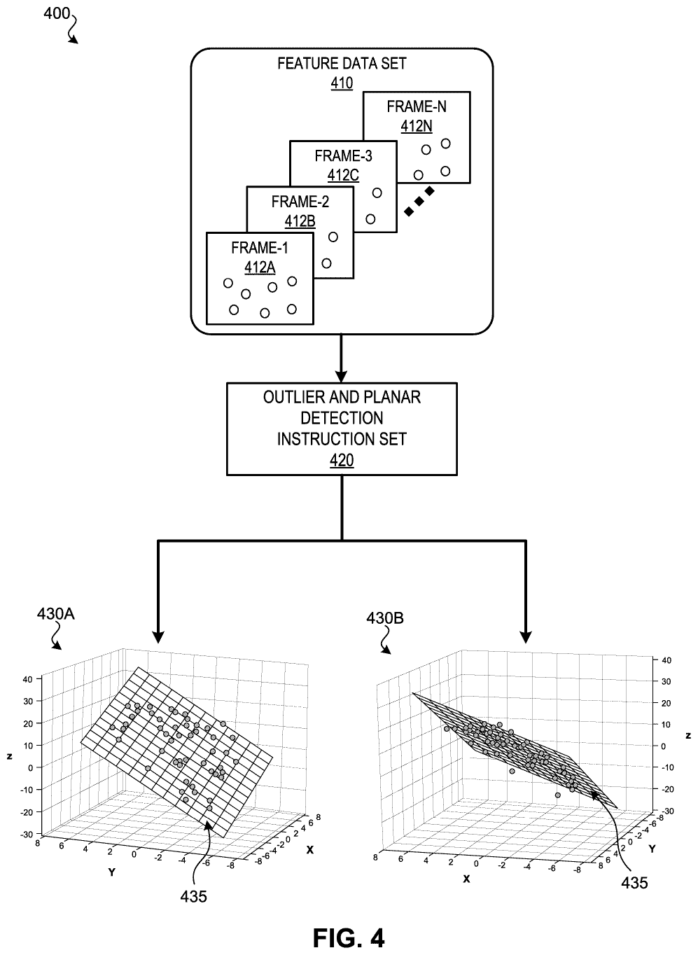

FIG. 4 illustrates an example environment 400 for detecting outlier's and planar structures associated with a plurality of features, in accordance with some implementations. For example, an outlier and planar detection instruction set 420 acquires a feature data set 410 which includes one or more frames 412 (e.g., frame-1 412A, frame-2 412B, frame-3 412C, through frame-N 412N) of identified features and their respective 2D display positions within each frame. Each feature (e.g., the feature of the center of the eye of the dinosaur character 150) may be located in a 3D space (e.g., X1Y1Z1 coordinates), but may be represented at a 2D display position for each frame.

In some implementations, and as illustrated in FIG. 4, the outlier and planar detection instruction set 420 then analyzes each 3D position of the identified features and maps out each outlier feature point (e.g., those that were determined to have a distance between a predicted projection feature point and an actual projection feature point greater than a threshold as discussed in FIG. 3 herein. For example, the outliers are illustrated and represented by the graphs 430A, 430B. Graph 430A and graph 430B illustrate the same set of feature points, but at a different perspective to illustrate the 3D structure of the set of identified feature points. The outlier and planar detection instruction set 420 then analyzes the set of outlier feature points and determines whether that set of 3D positions of features correspond to or approximately correspond to a planar structure. For example, each graph 430A, 430B, illustrate a detected planar structure 435 associated with the set of outlier feature points (e.g., identify a plane corresponding to moving content). In other words, the outlier and planar detection instruction set 420 may identify a television screen (e.g., screen 120) as a planar structure, and provide that detected planar structure 435 to a localization module to be excluded so that moving content (e.g., content 125 of the video being played on the television screen 120) may be ignored to avoid any potential errors with the localization techniques, such as, inter alia, vision-based tracking techniques (e.g., SLAM, etc.).

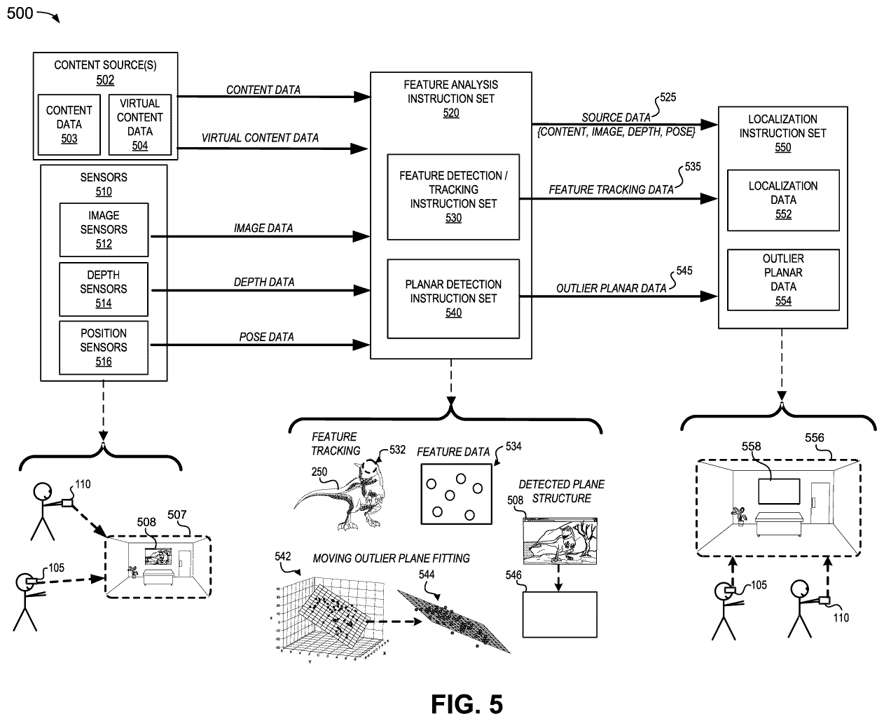

FIG. 5 illustrates a system flow diagram of an example environment 500 in which a system may exclude planar data while tracking an image-based pose of a device in a 3D coordinate system based on content motion detection, according to some implementations. In some implementations, the system flow of the example environment 500 is performed on a device (e.g., device 105 or 110 of FIG. 1), such as a mobile device, desktop, laptop, or server device. The images of the example environment 500 can be displayed on a device (e.g., device 110 of FIG. 1) that has a screen for displaying images and/or a screen for viewing stereoscopic images such as an HMD (e.g., device 105 of FIG. 1). In some implementations, the system flow of the example environment 500 is performed on processing logic, including hardware, firmware, software, or a combination thereof. In some implementations, the system flow of the example environment 500 is performed on a processor executing code stored in a non-transitory computer-readable medium (e.g., a memory).

In an exemplary implementation, the system flow of the example environment 500 acquires content data and optionally virtual content data to view on a device. Additionally, the example environment 500 acquires sensor data from one or more sensors 510, that includes image data from image sensors 512, depth data from depth sensors 514, device pose data from depth sensors 514, or a combination thereof for each frame of a sequence of frames of data. The content data 503 and virtual content data 504 may be obtained from one or more content sources 502. For example, content data 503 may be content 125 of FIG. 1, such as a 3D video, to be displayed as content 225 within an XR view, and virtual content data 504 may be a virtual object, such as an animated figure, i.e., a dinosaur, object 260 of FIG. 2A, 2B, appearing to be placed on a surface of desk and may be walking around within a view of a physical environment for augmented reality.

The content data, the image and depth data from an environment, and the pose data from a user's viewpoint, may be analyzed and used to improve the tracking of an image-based pose of a device in a 3D coordinate system by excluding outliers (e.g., features corresponding to moving content). For example, identified moving objects or content displayed on an object may be removed from the image-based pose tracking of the device. For example, a view of an XR environment that includes within the view a moving object in the physical environment, such as, inter alia, a television screen showing moving content as described herein, but may also include other moving physical objects such as a car driving by, other bystanders, pets, a user's/viewer's hands in front of the camera (or within view if wearing an HMD), and the like.

In an example implementation, the pose data may include camera positioning information such as position data (e.g., position and orientation data, also referred to as pose data) from position sensors 516 of a physical environment. The position sensors 608 may be sensors on a viewing device (e.g., device 105 or 110 of FIG. 1). For the pose data, some implementations include a visual inertial odometry (VIO) system to determine equivalent odometry information using sequential camera images (e.g., light intensity data) to estimate the distance traveled. Alternatively, some implementations of the present disclosure may include a SLAM system (e.g., using position sensors 516). The SLAM system may include a multidimensional (e.g., 3D) laser scanning and range measuring system that is GPS-independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In an example implementation, the environment 500 includes a feature analysis instruction set 520 that is configured with instructions executable by a processor to obtain content data, virtual content data, image data, depth data, and pose data (e.g., camera position information, etc.) to determine feature tracking data 535 and outlier planar data 545, and provide that determined data in combination with the source data 525 to the localization instruction set 550, using one or more of the techniques disclosed herein. In an example implementation, feature analysis instruction set 520 includes a feature detection/tracking instruction set 530 that is configured with instructions executable by a processor to obtain content data, image data, depth data, and pose data, and determine feature tracking data 535 using one or more feature detection and tracking techniques discussed herein. For example, feature analysis instruction set 520 may identify one or more features in a 2D image, such as the illustrated exemplary feature 532 (e.g., an eye) of the representation 250 of dinosaur character 150. Moreover, the feature detection/tracking instruction set 530 may identify each feature for each frame and identify a subset of those features that are in motion, as illustrated by the frame of feature data 534.

In an example implementation, the feature analysis instruction set 520 further includes a planar detection instruction set 540 that is configured with instructions executable by a processor to obtain the frames of feature data (e.g., the subset of detected features in motion) from the feature analysis instruction set 520 (e.g., frame of feature data 534) and determine outlier planar data 545. For example, the feature detection/tracking instruction set 530 may only identify a subset of the 3D positions of moving features, but if the subset of the 3D positions of moving features resembles a planar structure, then a plane may be robustly fitted. Thus, the 3D graph 542 illustrates an example planar structure 544 that best fits the detected subset of features that were identified as being in motion. The planar structure 544 may then be matched to the environment of the image data, thus the determined planar structure 546 matches the television screen 508 is identified as a planar structure that includes moving features (e.g., slow moving content—the dinosaur character 150) and therefore may be excluded by the device tracking/localization processes.

In an example implementation, the environment 500 further includes a localization instruction set 550 that is configured with instructions executable by a processor to obtain the source data 525 (e.g., content data, image data, depth data, pose data, etc.), feature tracking data 535, and outlier planar data 545, and determine/track an image-based pose of a device using one or more localization/tracking techniques discussed herein or as otherwise may be appropriate. For example, the localization instruction set 550 generates localization data 552 and outlier planar data 554 in order to update the tracking data by scanning the environment (e.g., image data 556), but excluding the detected planar structure 558 corresponding to the television screen 508. For example, the localization instruction set 550 analyzes RGB images from a light intensity camera with a sparse depth map from a depth camera (e.g., time-of-flight sensor), feature tracking data 535 (e.g., feature data 534 from the feature/detection tracking instruction set 530), outlier planar data 545 (e.g., plane estimation parameters from the planar detection instruction set 540), and other sources of physical environment information (e.g., camera positioning information such as pose data from an IMU, and other position information such as from a camera's SLAM system, or the like) to generate localization data 442 by tracking device location information for 3D reconstruction (e.g., a 3D model representing the physical environment of FIG. 1).

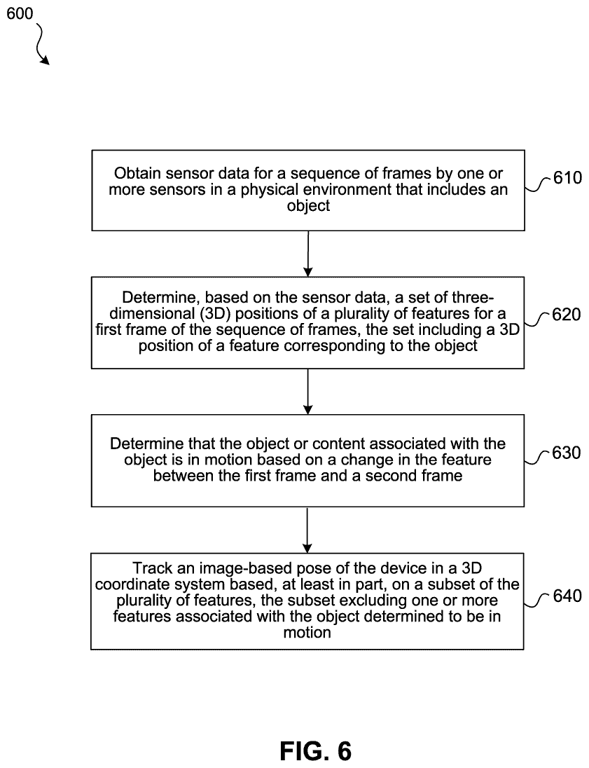

FIG. 6 is a flowchart illustrating a method 600 for tracking an image-based pose of a device in a 3D coordinate system based on content motion detection in accordance with some implementations. In some implementations, a device such as electronic device 110 performs method 600. In some implementations, method 600 is performed on a mobile device, desktop, laptop, HMD (e.g., device 110), or server device. The method 600 is performed by processing logic, including hardware, firmware, software, or a combination thereof. In some implementations, the method 600 is performed on a processor executing code stored in a non-transitory computer-readable medium (e.g., a memory). In some implementations, the device performing the method 600 includes a processor and one or more sensors.

Various implementations of the method 600 improve world tracking and localization of an electronic device (e.g., device 105, device 110, and the like) based on vision (e.g., stereo camera images) and inertial measurement unit (IMU) systems. In various implementations, this involves identifying features in image(s) that correspond to moving content and predicting feature locations or projections to identify and remove outliers associated with the moving content. For example, when there is moving content (e.g., a television screen displaying slow moving content, hands moving in front of device, car driving by, etc.) SLAM pose tracking may mistake the moving content as part of the physical environment. Mistaking moving content as part of the physical environment may reduce tracking and localization accuracy and may result in drift of virtual content that is positioned based on that tracking and localization.

At block 610, the method 600 obtains sensor data for a sequence of frames by one or more sensors in a physical environment that includes an object. In some implementations, the object may be a moving object, a television screen displaying moving content (e.g., television screen 120 displaying content 125), a car driving by, a hand waving in front of the camera, and the like. In some implementations, the object is in motion for at least a portion of frames of the sequence of frames (e.g., content 125 includes moving content such as, inter alia, a dinosaur character 150).

In some implementations, the sensor data including image data, depth data, device pose data, or a combination thereof for each frame of the sequence of frames. In some implementations, a sensor data signal includes image data (e.g., RGB data), depth data (e.g., lidar-based depth data, and/or densified depth data), device or head pose data, or a combination thereof, for each frame of the sequence of frames. For example, sensors on a device (e.g., camera's, IMU, etc. on device 105 or 110) can capture information about the position, location, motion, pose, etc., of the device and/or of the one or more objects in the physical environment. The depth sensor signal may include distance-to-object information such as lidar-based depth (e.g., depth information at various points in the scene at 1 HZ) and/or densified depth. In some implementations, the depth sensor signal includes distance information between a 3D location of the device and a 3D location of a surface of an object.

At block 620, the method 600 determines, based on the sensor data, a set of 3D positions of a plurality of features for a first frame of the sequence of frames, the set including a 3D position of a feature corresponding to the object. In some implementations, a feature may include a 2D feature detected on an image, such as an interest point that is represented by the pixel location. For example, as illustrated in FIG. 3 by area 312A at first point in time and 312B for a second point in time, a center of an eye of the moving content, the dinosaur character 150, may be identified and tracked as a feature. In some implementations, a subset of SLAM features may be identified based on the moving content (e.g., a set of multiple feature points associated with different identified features associated with the moving content, e.g., the dinosaur character 150).

In some implementations, feature matching may analyze two images to identify a single pixel location and triangulate those. Feature matching is a fundamental technique in computer vision that allows a system to find corresponding points between two images and works by detecting distinctive key points in each image and comparing their descriptors, which represent the unique characteristics of these key points.

At block 630, the method 600 determines that the object or content associated with the object is in motion based on a change in the feature between the first frame and a second frame. In particular, block 630 focuses on the determined distance difference between (1) the projected location of the first feature in the second frame, and (2) the actual location of the first feature in the second frame. For example, as illustrated in FIG. 3 for the identified feature of the dinosaur character 150 (e.g., a center of an eye), the system determines whether the distance between the projected location of the first feature in the second frame (e.g., predicted projection feature point 324) and the actual location of the first feature in the second frame (e.g., the actual location of the feature point 326) exceeds a distance threshold (e.g., based on a number of pixels). In other words, the system determines whether a feature of an object is in motion, and thus whether the object is in motion, based on a distance of change between the two frames.

In some implementations, determining that the object or content associated with the object is in motion based on a change in the feature between the first frame and the second frame includes determining a change in a motion sensor-based pose of the device between the first frame and a second frame of the sequence of frames (e.g., based on IMU data), determining a projected 2D position of the feature on the second frame based on the 3D position of the feature determined for the first frame and the change in the pose of the device, and determining whether the object or content associated with the object is in motion based on the projected 2D position of the feature and an actual 2D position of the feature in the second frame. For example, as illustrated in FIG. 3, the system may use an IMU to estimate where the next camera frame would be in space to project the previously observed feature to the estimated camera frame.

In some implementations, determining that the object or content associated with the object is in motion based on a change in the feature between the first frame and the second frame includes determining that a distance between (1) a 3D position of the projected location of the feature for the first frame in the second frame based on the IMU data and (2) a second 3D position of the feature for second frame (e.g., an actual location) exceeds a threshold. For example, a delta difference distance greater than a threshold distance between the predicted projection versus the actual feature location indicates that the feature is moving. The threshold may be based on a number of pixels as a distance measurement.

At block 640, the method 600 tracks an image-based pose of the device in a 3D coordinate system based, at least in part, on a subset of the plurality of features, the subset excluding one or more features associated with the object determined to be in motion. For example, based on detecting features that are in motion, the tracking/localization of the device may be determined by excluding those particular features that are in motion to avoid potential issues (e.g., virtual content drift).

In some implementations, the method 600 further includes determining that a set of 3D positions of features corresponding to the object correspond to or approximately correspond to a planar structure. For example, determining a set of outliers on a plane, and identify that plane to correspond to moving content and exclude other data on that plane (e.g., television screen 120).

In some implementations, the method 600 further includes determining 2D locations of the features corresponding to the planar structure and filtering a subsequent sequence of frames based on the 2D locations of the features corresponding to the planar structure. For example, the system may filter in a 3D coordinate system using the identified plane's geometry, project the plane back to the camera frame, and use features' 2D location for filtering.

In some implementations, determining that the object or content associated with the object is in motion is based on a pose of the device. In some implementations, the method 600 further includes determining a change in a position of a viewpoint of the device during the sequence of frames, and adjusting the image-based pose of the device in the 3D coordinate system based on the determined change in the position of the viewpoint.

In some implementations, the method 600 further includes presenting a view (e.g., one or more frames) of an extended reality (XR) environment on a display, wherein the view of the XR environment includes virtual content and at least a portion of the physical environment, wherein the portion of the physical environment includes the object For example, a view of an XR environment that includes within the view a moving object in the physical environment, such as, inter alia, a television screen showing moving content as described herein, but may also include other moving physical objects such as a car driving by, other bystanders, pets, a user's/viewer's hands in front of the camera (or within view if wearing an HMD), and the like.

In some implementations, the virtual content is adjusted based on determining to exclude the one or more features associated with the object determined to be in motion. For example, the virtual content may be updated around a breakthrough of a person of the virtual environment.

In some implementations, the image data is determined from an image sensor signal based on a machine learning model configured to identify image portions corresponding to the object. For example, an image sensor signal may provide images interpreted (e.g., by a machine learning model) to identify image portions corresponding to the object.

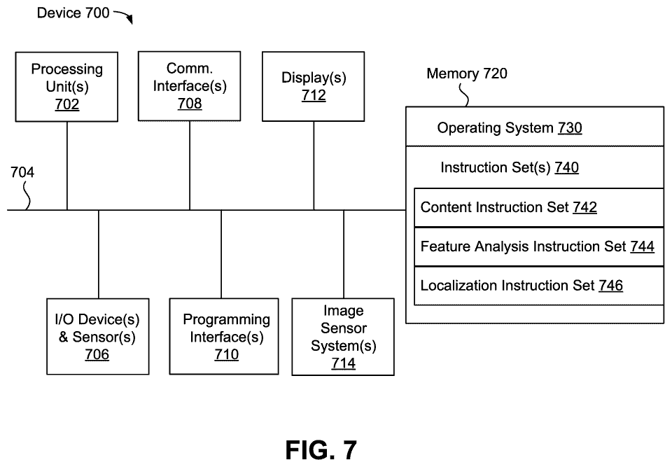

FIG. 7 is a block diagram of electronic device 700. Device 700 illustrates an exemplary device configuration for electronic device 110. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 700 includes one or more processing units 702 (e.g., microprocessors, ASICs, FPGAs, GPUs, CPUs, processing cores, and/or the like), one or more input/output (I/O) devices and sensors 706, one or more communication interfaces 708 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, 12C, and/or the like type interface), one or more programming (e.g., I/O) interfaces 710, one or more output device(s) 712, one or more interior and/or exterior facing image sensor systems 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 712 include one or more displays configured to present a view of a 3D environment to the user. In some implementations, the one or more device(s) 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 700 includes a single display. In another example, the device 700 includes a display for each eye of the user.

In some implementations, the one or more output device(s) 712 include one or more audio producing devices. In some implementations, the one or more output device(s) 712 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 712 may additionally or alternatively be configured to generate haptics.

In some implementations, the one or more image sensor systems 714 are configured to obtain image data that corresponds to at least a portion of a physical environment. For example, the one or more image sensor systems 714 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 714 further include illumination sources that emit light, such as a flash. In various implementations, the one or more image sensor systems 714 further include an on-camera image signal processor (ISP) configured to execute a plurality of processing operations on the image data.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 includes a non-transitory computer readable storage medium.

In some implementations, the memory 720 or the non-transitory computer readable storage medium of the memory 720 stores an optional operating system 730 and one or more instruction set(s) 740. The operating system 730 includes procedures for handling various basic system services and for performing hardware dependent tasks. In some implementations, the instruction set(s) 740 include executable software defined by binary information stored in the form of an electrical charge. In some implementations, the instruction set(s) 740 are software that is executable by the one or more processing units 702 to carry out one or more of the techniques described herein.

The instruction set(s) 740 includes a content instruction set 742, a feature analysis instruction set 744, and a localization instruction set 746. The instruction set(s) 740 may be embodied a single software executable or multiple software executables.

In some implementations, the content instruction set 742 is executable by the processing unit(s) 702 to provide and/or track content for display on a device. The content instruction set 742 may be configured to monitor and track the content over time (e.g., during an experience) and/or to identify change events that occur within the content (e.g., based on identified/classified behavior gaze events). To these ends, in various implementations, the instruction includes instructions and/or logic therefor, and heuristics and metadata therefor.

In some implementations, the feature analysis instruction set 744 is executable by the processing unit(s) 702 to obtain content data, image data, depth data and pose data (e.g., camera position information, etc.) and to determine feature tracking data and/or outlier planar data, using one or more of the techniques disclosed herein. To these ends, in various implementations, the instruction includes instructions and/or logic therefor, and heuristics and metadata therefor.

In some implementations, the localization instruction set 746 is executable by the processing unit(s) 702 to obtain the source data (e.g., content data, image data, depth data, pose data, etc.), feature tracking data, and outlier planar data, and determine/track an image-based pose of a device using one or more localization/tracking techniques discussed herein or as otherwise may be appropriate. To these ends, in various implementations, the instruction includes instructions and/or logic therefor, and heuristics and metadata therefor.

Although the instruction set(s) 740 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

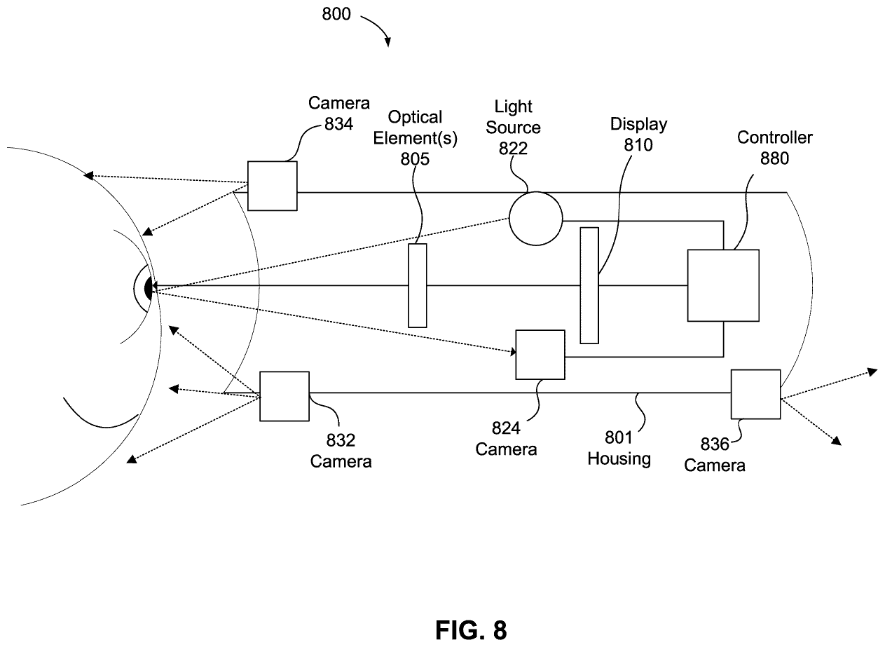

FIG. 8 illustrates a block diagram of an exemplary head-mounted device 800 in accordance with some implementations. The head-mounted device 800 includes a housing 801 (or enclosure) that houses various components of the head-mounted device 800. The housing 801 includes (or is coupled to) an eye pad (not shown) disposed at a proximal (to the user 102) end of the housing 801. In various implementations, the eye pad is a plastic or rubber piece that comfortably and snugly keeps the head-mounted device 800 in the proper position on the face of the user 102 (e.g., surrounding the eye of the user 102).

The housing 801 houses a display 810 that displays an image, emitting light towards or onto the eye of a user 102. In various implementations, the display 810 emits the light through an eyepiece having one or more optical elements 805 that refracts the light emitted by the display 810, making the display appear to the user 102 to be at a virtual distance farther than the actual distance from the eye to the display 810. For example, optical element(s) 805 may include one or more lenses, a waveguide, other diffraction optical elements (DOE), and the like. For the user 102 to be able to focus on the display 810, in various implementations, the virtual distance is at least greater than a minimum focal distance of the eye (e.g., 7 cm). Further, in order to provide a better user experience, in various implementations, the virtual distance is greater than 1 meter.

The housing 801 also houses a tracking system including one or more light sources 822, camera 824, camera 832, camera 834, camera 836, and a controller 880. The one or more light sources 822 emit light onto the eye of the user 102 that reflects as a light pattern (e.g., a circle of glints) that may be detected by the camera 824. Based on the light pattern, the controller 880 may determine an eye tracking characteristic of the user 102. For example, the controller 880 may determine a gaze direction and/or a blinking state (eyes open or eyes closed) of the user 102. As another example, the controller 880 may determine a pupil center, a pupil size, or a point of regard. Thus, in various implementations, the light is emitted by the one or more light sources 822, reflects off the eye of the user 102, and is detected by the camera 824. In various implementations, the light from the eye of the user 102 is reflected off a hot mirror or passed through an eyepiece before reaching the camera 824.

The display 810 emits light in a first wavelength range and the one or more light sources 822 emit light in a second wavelength range. Similarly, the camera 824 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 102 selects an option on the display 810 by looking at it), provide foveated rendering (e.g., present a higher resolution in an area of the display 810 the user 102 is looking at and a lower resolution elsewhere on the display 810), or correct distortions (e.g., for images to be provided on the display 810).

In various implementations, the one or more light sources 822 emit light towards the eye of the user 102 which reflects in the form of a plurality of glints.

In various implementations, the camera 824 is a frame/shutter-based camera that, at a particular point in time or multiple points in time at a frame rate, generates an image of the eye of the user 102. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

In various implementations, the camera 824 is an event camera including a plurality of light sensors (e.g., a matrix of light sensors) at a plurality of respective locations that, in response to a particular light sensor detecting a change in intensity of light, generates an event message indicating a particular location of the particular light sensor.

In various implementations, the camera 832, camera 834, and camera 836 are frame/shutter-based cameras that, at a particular point in time or multiple points in time at a frame rate, may generate an image of the face of the user 102 or capture an external physical environment. For example, camera 832 captures images of the user's face below the eyes, camera 834 captures images of the user's face above the eyes, and camera 836 captures the external environment of the user (e.g., environment 100 of FIG. 1). The images captured by camera 832, camera 834, and camera 836 may include light intensity images (e.g., RGB) and/or depth image data (e.g., Time-of-Flight, infrared, etc.).

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising: at a device having a processor and one or more sensors:
obtaining sensor data for a sequence of frames by the one or more sensors in a physical environment, wherein the physical environment includes an object;
determining, based on the sensor data, a set of three-dimensional (3D) positions of a plurality of features for a first frame of the sequence of frames, the set of 3D positions including a 3D position of a feature corresponding to the object;
determining that the object or content associated with the object is in motion based on a change in the feature between the first frame and a second frame; and
in response to determining that the object or content associated with the object is in motion, tracking an image-based pose of the device in a 3D coordinate system based, at least in part, on a subset of the plurality of features, the subset excluding one or more features associated with the object determined to be in motion.

2. The method of claim 1, wherein determining that the object or content associated with the object is in motion based on a change in the feature between the first frame and the second frame comprises:
determining a change in a motion sensor-based pose of the device between the first frame and a second frame of the sequence of frames;
determining a projected two-dimensional (2D) position of the feature on the second frame based on the 3D position of the feature determined for the first frame and the change in the pose of the device; and
determining whether the object or content associated with the object is in motion based on the projected 2D position of the feature and an actual 2D position of the feature in the second frame.

3. The method of claim 1, wherein determining that the object or content associated with the object is in motion based on a change in the feature between the first frame and the second frame comprises:
determining that a distance between a first 3D position of the feature for the first frame and a second 3D position of the feature for second frame exceeds a threshold.

4. The method of claim 1, further comprising:
determining that a set of 3D positions of features corresponding to the object correspond to or approximately correspond to a planar structure.

5. The method of claim 4, further comprising:
determining 2D locations of the features corresponding to the planar structure; and
filtering a subsequent sequence of frames based on the 2D locations of the features corresponding to the planar structure.

6. The method of claim 1, wherein the object is in motion for at least a portion of frames of the sequence of frames.

7. The method of claim 1, wherein determining that the object or content associated with the object is in motion is based on a pose of the device.

8. The method of claim 1, further comprising:
determining a change in a position of a viewpoint of the device during the sequence of frames; and
adjusting the image-based pose of the device in the 3D coordinate system based on the determined change in the position of the viewpoint.

9. The method of claim 1, further comprising: presenting a view of an extended reality (XR) environment on a display, wherein the view of the XR environment comprises virtual content and at least a portion of the physical environment, wherein the portion of the physical environment includes the object.

10. The method of claim 9, wherein the virtual content is adjusted based on determining to exclude the one or more features associated with the object determined to be in motion.

11. The method of claim 1, wherein the sensor data is determined from an image sensor signal based on a machine learning model configured to identify image portions corresponding to the object.

12. The method of claim 1, wherein the sensor data comprises image data, depth data, device pose data, or a combination thereof, for each frame of the sequence of frames.

13. The method of claim 1, wherein the device comprises a head-mounted device (HMD).

14. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
obtaining sensor data for a sequence of frames by the one or more sensors in a physical environment, wherein the physical environment includes an object;
determining, based on the sensor data, a set of three-dimensional (3D) positions of a plurality of features for a first frame of the sequence of frames, the set of 3D positions including a 3D position of a feature corresponding to the object;
determining that the object or content associated with the object is in motion based on a change in the feature between the first frame and a second frame; and
in response to determining that the object or content associated with the object is in motion, tracking an image-based pose of the device in a 3D coordinate system based, at least in part, on a subset of the plurality of features, the subset excluding one or more features associated with the object determined to be in motion.

15. The device of claim 14, wherein determining that the object or content associated with the object is in motion based on a change in the feature between the first frame and the second frame comprises:
determining a change in a motion sensor-based pose of the device between the first frame and a second frame of the sequence of frames;
determining a projected two-dimensional (2D) position of the feature on the second frame based on the 3D position of the feature determined for the first frame and the change in the pose of the device; and
determining whether the object or content associated with the object is in motion based on the projected 2D position of the feature and an actual 2D position of the feature in the second frame.

16. The device of claim 14, wherein determining that the object or content associated with the object is in motion based on a change in the feature between the first frame and the second frame comprises:
determining that a distance between a first 3D position of the feature for the first frame and a second 3D position of the feature for second frame exceeds a threshold.

17. The device of claim 14, wherein the non-transitory computer-readable storage medium further comprises program instructions that, when executed on the one or more processors, cause the one or more processors to perform operations comprising:
determining that a set of 3D positions of features corresponding to the object correspond to or approximately correspond to a planar structure.

18. The device of claim 17, wherein the non-transitory computer-readable storage medium further comprises program instructions that, when executed on the one or more processors, cause the one or more processors to perform operations comprising:
determining 2D locations of the features corresponding to the planar structure; and
filtering a subsequent sequence of frames based on the 2D locations of the features corresponding to the planar structure.

19. The device of claim 14, wherein the object is in motion for at least a portion of frames of the sequence of frames.

20. A non-transitory computer-readable storage medium, storing program instructions executable on a device to perform operations comprising:
obtaining sensor data for a sequence of frames by the one or more sensors in a physical environment, wherein the physical environment includes an object;
determining, based on the sensor data, a set of three-dimensional (3D) positions of a plurality of features for a first frame of the sequence of frames, the set of 3D positions including a 3D position of a feature corresponding to the object;
determining that the object or content associated with the object is in motion based on a change in the feature between the first frame and a second frame; and
in response to determining that the object or content associated with the object is in motion, tracking an image-based pose of the device in a 3D coordinate system based, at least in part, on a subset of the plurality of features, the subset excluding one or more features associated with the object determined to be in motion.
